(19) United States
(12) Patent Application Publication
(10) Pub. No.: US 2013/0081293 A1
(43) Pub. Date: Apr. 4, 2013

(54) METHOD FOR DETERMINING A POSITION CHANGE OF A TOOL AND THE TOOL AND THE TOOL CONTROL UNIT

(71) Applicant: Dritte Patentportfolio Beteiligungsgesellschaft mbH & Co. KG, Schoenefeld/Waltersdorf (DE)

(72) Inventors: Marcus DELIN, Ellerau (DE); Normen FUCHS, Rostock (DE)

(73) Assignee: Dritte Patentportfolio Beteiligungsgesellschaft mbH & Co. KG, Schoenefeld/Waltersdorf (DE)

(21) Appl. No.: 13/621,937

(22) Filed: Sep. 18, 2012

(30) Foreign Application Priority Data
Sep. 20, 2011 (DE) 102011053798.8

(51) Int. Cl. G01B 21/16

(52) U.S. Cl. CPC G01B 21/16
USPC 33/301; 33/365

(57) ABSTRACT

A method for determining a position change of a handheld tool in space includes: alignment of an initial tool position with a reference position to determine at least a first position vector of the tool, at least one component of the first position vector being determined by measurement of a component of the gravitational acceleration in the direction of a predetermined axis of the tool;

establishing a modification of the tool position during an actual position change by determining at least one angular discrepancy of a second position vector of at least one temporally preceding position vector, at least one component of the second position vector being determined after the position change by measuring the component of the gravitational acceleration in the direction of the predetermined axis of the tool; and providing information relating to the orientation of the tool established from the at least one angular discrepancy.

### BACKGROUND OF THE INVENTION

The invention relates to a method for determining a position change of a handheld tool in space and a tool and tool control unit for carrying out such a method.

In spite of significantly advancing technological development, for instance, in the field of robot technology, handheld tools continue to be highly sought after, in particular for specific applications and for applications which are not advantageous on an industrial scale. In this instance, a material is processed by way of a handheld tool which is manually handled by an operator or a worker. However, in order to achieve satisfactory operating results, a high level of skill and long-term experience in handling the tool are sometimes required. Depending on the requirements or the task, the worker adapts the operating properties of the tool. Typically, modifications of the control parameters in the tool control unit are carried out for this purpose, whereby the tool can be used in various operating modes.

For instance, it is necessary, for example, in the case of a welding tool, to take into account the spatial geometric arrangement of the materials to be welded in order to be able to produce a high-quality weld seam. In the same manner, it is necessary in the case of a spraying tool to take into account the geometric arrangement of the surfaces to be sprayed so that the most consistent and uniform layer of spray agent possible can be applied.

However, the problem with such a modification of the operating mode of a tool is that the worker must briefly interrupt the work in order to be able to carry out appropriate adjustment of the tool control unit. This operation not only reduces the efficiency of the entire working operation but it is also sometimes difficult to continue the work with the same high level of quality. For example, when carrying out welding operations with a welding tool, after an interruption, an undesirable weld transition may occur which may be not only aesthetically but also technically disadvantageous for the entire welding result.

In order to avoid such disadvantages, European Patent Publication No. EP 1 812 200 B1 proposes an automatic tool control unit which can sense, by way of a sensor which is fitted to an operating head of the tool, the position and/or the position change of the operating head relative to a reference position of the operating head. In accordance with a correspondingly determined position or position change of the operating head, the tool control unit is capable of influencing a characteristic variable of the tool operation in accordance with the sensed position or position change. Consequently, the tool control unit is capable in each case of changing the operating mode when, for example, the operating head is moved by the worker into a position which requires other operating or working conditions. For instance, in particular when carrying out a welding operation using a welding head, the welding current or the welding voltage can always be decreased when the welding head is moved in an overhead position or in a horizontal position. Consequently, interruption of work can be avoided since the worker no longer has to manually carry out changes to the tool control unit in order to react to changed working conditions.

However, a disadvantage of the method according to EP 1 812 200 B1 is that the establishment of the position or the position change requires a high level of processing complexity. In order to be able to establish the position or position change in space, in the most simple case the three spatial co-ordinates x, y and z have to be determined at each time. In addition, information is required relating to how the operating head is orientated with respect to a predetermined spatial position. To this end, in the most simple case two angular variables, the polar angle and the azimuth angle, are required which are capable of determining the rotation or orientation of the operating head with respect to a spatial position of the operating head. However, the temporally continuous determination of these variables and electronic processing requires a level of complexity which may be disadvantageous, in particular in the case of rapid and frequent position changes of the operating head.

Consequently, it is desirable to provide a method for determining a position change of a handheld tool in space or such a tool with a tool control unit which overcomes the disadvantages of the prior art. In particular, it is desirable to provide a method and a tool having a tool control unit which afford a simple and practical possibility for determining a position change of a handheld tool.

### BRIEF SUMMARY OF THE INVENTION

In particular, a method for determining a position change of a handheld tool in space, includes: alignment of an initial tool position with a reference position in order to determine at least a first position vector of the tool, at least one component of the first position vector being determined by the measurement of a component of the gravitational acceleration in the direction of a predetermined axis of the tool; detecting a change of the tool position during an actual position change of the tool in space by determining at least one angular discrepancy of a newly determined, second position vector of at least one temporally preceding position vector, a component of the second position vector being determined after the position change by measuring the component of the gravitational acceleration in the direction of the predetermined axis of the tool; providing information relating to the orientation of the tool, which is established from the at least one angular discrepancy.

A core notion of the present invention is that the determination of a position change is first based on the determination of individual position vectors. In this instance, a first position vector is to be determined at the beginning of the operating process, which may constitute a reference position of the tool for temporally subsequent position vectors. The determination of the reference position is thus carried out via the definition of an initial tool position in which the manual worker holds the tool. If the worker now moves the tool during an operating procedure, there results a spatial position change of the tool which is determined by way of an angular discrepancy of a newly determined position vector of a temporally preceding position vector or a first-determined position vector of the tool. In this instance, the at least one determined angular discrepancy forms the single correcting or controlled variable for the adjustment of an operating mode of the tool. Owing to the information relating to the at least one angular discrepancy, the spatial position change of the tool can be determined to a sufficient degree so that the tool control unit can react to various operating conditions in an appropriate manner.

Owing to the fact that the position change is (at least partially) determined by a component of the gravitational acceleration or the gravitational acceleration vector in the direction of a predetermined axis of the tool, the determination of the position change is particularly simplified. By the component of the gravitational acceleration being measured in the direction of a predetermined axis of the tool, this component changes when the tool is rotated. A significant aspect of the invention is consequently that, from a variation of a specific component of the gravitational acceleration measured in the direction of a predetermined axis of the tool, a rotation of the tool can be inferred. If the predetermined axis of the tool is initially, for example, in the direction of the gravitational acceleration, the measurement of a component of the gravitational acceleration in the direction of the predetermined axis would produce a maximum value. If the tool is now rotated through 90° (which corresponds to a position change of the tool), the component of the gravitational acceleration in the direction of the predetermined axis would produce a value of (ideally) zero. If the tool is tilted, for example, through 180°, the component of the gravitational acceleration corresponds to the maximum value (but with a reversed prefix).

A significant aspect of the invention is also that the determination of the position changes is carried out with a handheld tool. The term handheld tool is intended to refer to a tool which is constructed to enable manual operation by a worker. Such handheld tools are distinguished, for example, by a handle and the like which enable the worker to move and tilt the tool. The term “handheld” is particularly intended not to refer to any automatic device, for example, a robot or the like, which is moved purely indirectly, for example, by the actuation of buttons or the setting of programs. Such automatic devices particularly have no gripping element for a worker.

The term a “predetermined axis” of the tool is intended to refer to any axis which is defined by the tool in such a manner that it rotates with the tool. The axis is consequently fixed with respect to the tool. The axis may preferably be an axis of symmetry and/or an axis which is defined by the discharge direction of a material.

In contrast to EP 1 812 200 B1, a position change is not carried out by way of a sensor which includes a hollow member with mercury. In the present invention, there is instead provided at least one acceleration sensor. Furthermore, in this instance, the determination of the spatial position change is carried out not by way of a precise description of the tool or the spatial orientation of the tool, but instead based only on at least one angular discrepancy of a position vector which differs from a temporally preceding position vector. Owing to the initial initiation or alignment of the tool position with a reference position for determining the first position vector of the tool, a determination of the absolute spatial position of the tool is no longer required. Instead, it is sufficient to determine the change of the tool position over time in order to be able to determine whether the tool should be operated by the tool control unit in a different operating mode. Since various operating modes can only be determined in accordance with the relative tool position with respect to a workpiece, it has been found to be sufficient to determine this relative position or the spatial position changes of the tool by way of only at least one angular discrepancy.

The alignment of the tool position with a reference position may be carried out, for example, if the tool is located in a retention member with a precisely defined position and orientation. It is also possible for the alignment of an operator to be initiated by pressing a button.

In embodiments which are different again, there may also be provision for the alignment to be carried out automatically.

In this instance, it should also be noted that the at least one angular discrepancy is intended to be understood neither in the context of a polar angle, nor that of an azimuth angle in a polar co-ordinate system. It is sufficient to determine the spatial angular discrepancy of two position vectors in order to draw conclusions regarding the actual spatial position change of the tool. From this position change or from this at least one control variable, it can already be established whether or not a new operating mode is intended to be adjusted by the tool control unit for the tool.

According to the invention, it is thus possible, owing to greatly reduced information, that is to say, the at least one angular discrepancy, to ensure appropriate operation of a tool in the context of automatic control or adjustment. According to the method for determining a spatial position change of a handheld tool, the at least one angular discrepancy allows information relating to the orientation of the tool to be provided in a form which can be received, for example, by the workpiece control system, in an appropriate manner. The information relating to the orientation of the tool may in this instance be apparent only in the value of the angular discrepancy or also in a data value which has already been further processed.

Another core aspect of the present invention is that the method according to the invention is independent of the tool geometry or a sensor which may be fitted to the tool. Instead, the method according to the invention is an indirect measurement method which also allows a high degree of flexibility with respect to the positioning of such sensors on the tool. The tool geometry in this instance may be used in order to support the method, but this is not necessary since initially the tool position is aligned with a reference position in order to determine at least a first position vector. The independence of the method according to the invention from the geometric conditions of the tool or from a potential positioning of the sensor on the tool further allows the method to be carried out by way of a retrofittable orientation determination unit on a tool having a tool control unit which is already provided.

According to a particularly preferred embodiment of the method according to the invention, the establishment of the change of the tool position is carried out by way of at least one sensor which is fitted to the tool and which directly or indirectly establishes the at least one angular discrepancy. A direct establishment could be carried out, for example, by way of appropriate inclination sensors. An indirect establishment is possible, for example, by way of sensors which can track the movement or acceleration status of the tool in the working process. After simple evaluation of the sensor information, the at least one angular discrepancy can consequently be determined, which can be provided as further information for orientation of the tool. However, it is required that the at least one sensor which is fitted to the tool remain connected to the tool during the operating procedure. In this instance, the at least one sensor can be adapted to the tool geometry or integrated in the tool in an appropriate manner. The at least one sensor is preferably integrated in a gripping region of the tool. However, owing to the initial alignment of the tool position with a reference position in order to determine the at least one first position vector of the tool, the position of the sensor has no further influence on the method according to the invention. However, it may also be advantageous, in order to determine a more precise tool position, to use or also to predetermine the positioning of the sensor with respect to the tool geometry.

According to another embodiment of the method according to the invention, the at least one angular discrepancy is at least 0 degrees and a maximum of 180 degrees. It is thus only necessary, for instance, with welding tools for carrying out welding operations, to determine which position or orientation the welding tool has with respect to the field of gravitational acceleration since, depending on the relative position with respect to the direction of the gravitational acceleration, the welding operation may be carried out with relatively large or small input of welding energy into the material to be processed. In this instance, however, it is sufficient to know which value the angular discrepancy has in the range between 0 degrees and 180 degrees with respect to the direction of the gravitational acceleration. Consequently, a further reduction of the information to be processed by the tool control unit can be brought about, which allows more rapid and efficient monitoring, control or regulation by the tool control unit.

According to another advantageous embodiment of the method according to the invention, the determination of at least one angular discrepancy involves the determination of an inclined position of the tool relative to a position vector. The inclined position, in addition to the at least one angular discrepancy, provides further information relating to the orientation of the tool relative to a position vector. In this instance, the inclined position establishes the relative rotation of the tool with respect to the position vector and may, for example, be reproduced by way of a polar and/or azimuth angle. Taking into account an inclined position of the tool allows the precise tool orientation with respect to a workpiece to be processed to be taken into account and may sometimes be advantageous for complex operations.

According to another embodiment of the method according to the invention, the reference position is determined by the direction of the gravitational acceleration. Consequently, in order to determine the first position vector of the tool during the process of alignment of the initial tool position, the tool is initialised in a predetermined relative position with respect to the direction of the gravitational acceleration. For initialisation, for example, a predetermined axis of the tool, for example, the torch head of a welding tool, is moved into a perpendicular position, whereby correspondence with the direction of the gravitational acceleration is carried out. The first position vector determined in this orientation is established, stored and can now constitute a reference vector for all further determined position vectors. When the tool is changed, new position vectors are now determined in appropriate time intervals and electronically compared with the stored first position vector. The comparison enables the determination of the at least one angular discrepancy and consequently a statement relating to the current spatial orientation of the tool. If the at least one angular discrepancy is between 0 degrees and 180 degrees, for example, the first position vector acting as an initialisation vector corresponds to an orientation of 0 degrees with respect to the direction of the gravitational acceleration. For 180 degrees, the first position vector and the temporally subsequently determined position vector are orientated in opposite directions, which substantially corresponds to an overhead position of the tool. At 90 degrees, the tool is retained, for example, in a horizontal orientation.

According to another embodiment of the method according to the invention, the determination of the angular discrepancy is carried out by calculating the quotient from the scalar product and the absolute product between a newly established position vector and at least one temporally preceding position vector. The determination of the angular discrepancy is in this instance particularly easy to achieve in an electronic manner. According to the calculation of the quotient from the scalar product and the absolute product between two position vectors, the cosine of the intermediate angle can first be determined, from which the intermediate angle can readily be determined itself by way of trigonometric calculation.

According to another extremely advantageous aspect of the method according to the invention, the acceleration sensor(s) is/are static acceleration sensors and the at least one angular discrepancy is calculated by way of static acceleration values of the sensors. In this instance, static, three-axis acceleration sensors have been found to be advantageous and allow the static gravitational acceleration to be determined in three axes and in addition also dynamic acceleration values which result from a movement change. In order to determine the orientation of the tool, however, only the static acceleration portions are required in this instance. However, the dynamic acceleration portions can be used for further functions. However, it is also alternatively advantageous to use three single-axis acceleration sensors which are secured to the tool with an appropriate orientation relative to each other.

The type of sensors which are suitable for use in the method according to the invention differ in terms of measurement range, precision or resolution, size, data transmission and the price thereof. According to suitable embodiments of such sensors, the measurement range may be selected to be in the range between −2 g and +2 g (g in this instance corresponds to the value of the gravitational acceleration). The sensors are preferably robust and impact-sensitive and can further be used over a relatively large temperature range. Such a temperature range extends, for example, between −15° C. and +100° C. The size of such sensors typically determines the resolution or precision of the sensor and can, depending on the operation, have an edge length of from a few millimetres up to an edge length of over 1 cm. In addition, there are analogue and digital sensors which can preferably be used for the method according to the invention. The data transmission may be carried out, for example, by way of a voltage signal via an I²C- or SPI Bus.

According to another embodiment of the method according to the invention, such sensors also have additional functionalities, such as, for example, a recognition of freefall or threshold values for suitable filtering and signal processing. A freefall detection enables, for example, the implementation of appropriate safety functions, for instance, when the tool falls in an uncontrolled manner from the hands of a worker. It is, for instance, possible to automatically switch off a welding torch in the event of a freefall. It is further also possible, using predetermined tapping signals on or with the tool to adjust an appropriate operating mode using the tool control unit. Such additional functions may be supported in a selective manner by the tool control unit.

According to another embodiment of the method according to the invention, the sensor(s) include(s) a three-axis acceleration sensor. Alternatively, three single-axis acceleration sensors may also be included.

According to another aspect of the method according to the invention, the acceleration sensor(s) may detect dynamic acceleration values which are suitable for determining at least one speed component of the tool. The dynamic acceleration values may typically be used for additional functions. It is thus possible, for example, by integrating dynamic acceleration values over time, to calculate an appropriate speed component. If the at least one speed component determined in this manner is also corrected, for example, with respect to the transverse accelerations occurring, or the transverse accelerations are compensated for, it is also possible to thereby establish a welding speed. Such a welding speed may, for example, be used in place of or also in addition to orientation information for the adjustment of the information relating to the orientation of the tool.

It is further possible to also use dynamic acceleration values in order to differentiate movements from each other. For example, when welding using a welding tool, the differentiation of the welding direction in an upward direction (Position PF according to DIN EN ISO 6947) and in a downward direction (Position PG according to DIN EN ISO 6947) is important information which enables improved control or regulation of the tool by the tool control unit.

According to another embodiment of the method according to the invention, the acceleration values of at least one sensor are calculated relative to the value of the gravitational acceleration. The value of the gravitational acceleration is typically predetermined in this instance. Accordingly, the determination of the at least one angular discrepancy of a newly determined position vector from a temporally preceding position vector can be facilitated, only relative values being calculated.

According to another aspect of the method according to the invention, the determination of the at least one angular discrepancy is carried out continuously at regular time intervals after the alignment of the initial tool position, preferably at a frequency of at least 100 Hz, in particular of at least 10 Hz and preferably at least 1 Hz. Depending on the operating method, relatively fast movement changes which lead to a position change of the handheld tool can also thus be established and contribute to the calculation of the at least one angular discrepancy. For conventional welding methods using handheld tools, in particular a frequency of 1 Hz may already be sufficient since, with a continuous welding process, no such rapid changes of the tool position are carried out that a time resolution of below one second appears to be necessary. In particular, it is also possible to then carry out the determination of the at least one angular discrepancy in relatively short time periods when the tool is not yet operational, but an initial tool position has been achieved for alignment of a reference position. If the operation is started with the tool, the determination of the at least one angular discrepancy may occur in relative terms more slowly in terms of time. If a detection of a fall, for example, with resultant switching-off of the tool, is also intended to be provided, relatively rapid detection of the angular position may again also be advantageous during operation. Consequently, it would be possible, for example, when a fall status is detected, for the tool to be switched off before the tool potentially strikes the floor.

According to another aspect of the method for determining a position change of a handheld tool, the establishment of the information relating to the orientation of the tool from the at least one angular discrepancy takes into account the position of the sensor on the tool. Taking into account the position of the sensor on the tool enables, for example, the rotation of the tool relative to a position vector to be determined so that the orientation of the tool and the component to be processed can be determined in a substantially unambiguous manner. For example, it is thereby possible to obtain or calculate an item of information relating to position or orientation which provides information relating to the angle at which the tool is orientated with respect to the material to be processed. It is, for example, conceivable with a welding method, via the angle of incidence of the tool relative to the material, to determine the energy input per surface-area on the material and consequently, in the event of unsuitable values, to adjust or track the welding current or welding voltage or welding parameters in general. In the case of drilling or milling methods and joining methods or spray methods, it may also be advantageous to influence the quality of the operating result by way of an advantageous relative orientation of the workpiece to be processed and of the tool. When the precise position of the sensor on the tool is known and when the tool geometry is taken into account, the information available is sufficient to determine the position or orientation of the tool in an unambiguous manner.

According to another embodiment of the method according to the invention, the temporally preceding position vector for determining at least one angular discrepancy is a predetermined reference vector, in particular the reference vector of the gravitational force. According to the embodiment, the at least one angular discrepancy is thus always determined with reference to the direction of the gravitational field, whereby orientation information which is sufficient for most operations can be determined. Preferably, the gravitational force and the direction of the gravitational force can be determined with a sensor which is provided specifically for that purpose so that, at each time of the determination of at least one angular discrepancy, a suitable value of the gravitational force and a suitable direction vector are available. Such a reference vector can also be stored beforehand in the tool control unit.

According to another embodiment of the method according to the invention, after the provision of information relating to the orientation of the tool, at least one control variable of the tool is established, which is provided for transmission to a tool control unit. The establishment of the at least one control variable can in this instance take place in the tool control unit itself or in a device which is arranged upstream thereof. Accordingly, the tool control unit may receive suitable control or regulation variables which can be directly converted and used to control or regulate an operating mode of the tool. Accordingly, the method according to the embodiment allows rapid and effective provision of at least one such control variable.

According to another embodiment of the method according to the invention, the information provided relating to the orientation of the tool and/or the value of the at least one control variable are stored in a data store. The store on the one hand allows the worker to continuously monitor the working process and can also be made available to him for practice and training purposes in a suitably prepared manner. Furthermore, the data storage allows the working process to be monitored with respect to quality assurance and can contribute to elimination of errors or error analyses.

According to another embodiment of the method according to the invention, in addition to information relating to the orientation of the tool, at least one control parameter is also provided when the tool carries out a predetermined spatial position change which can be established as a predetermined acceleration pattern. A control parameter can, in the context of a control variable, constitute information relating to further processing by a tool control unit. In particular, a control parameter is a control variable which can be received in an unmodified form by the tool control unit for control or regulation. Spatial position changes in accordance with the embodiment are, for example, acceleration peaks and acceleration stages which signal undesirable tool guiding. For example, in the case of a tool being unintentionally dropped, in particular a welding tool, an acceleration stage is established which signals undesirable tool guiding or tool guiding which is dangerous for the worker. Alternatively, specific patterns, for example, specific sudden accelerations and rotations of the tool may indicate a freefall. Accordingly, suitable information or at least one control parameter can be provided, which is converted by a tool control unit into an emergency stop.

According to another aspect of the method according to the invention, the alignment of an initial tool position with a reference position allows the determination of two position vectors of the tool which are located perpendicularly with respect to each other and which define a two-dimensional co-ordinate system and the establishment of the change of the tool position during an actual spatial position change of the tool involves the establishment of a newly determined position vector in projection onto the co-ordinate system. Such a projection onto an initially determined co-ordinate system allows the user to indicate a direction in which his tool, for example, deviates or tilts during handling or in which direction a correction to achieve a desired operating result would have to be carried out. In the most simple case, the defined two-dimensional co-ordinate system is an orthogonal co-ordinate system in which the co-ordinates of the reference position and the current position vector of the tool are calculated. Subsequently, by way of simple trigonometric calculations, a discrepancy of the tool position (actual position) from the desired reference position (origin of the co-ordinate system) can be calculated, which can subsequently be supplied to the worker in an appropriate form in order to direct him to selectively carry out the handling of the tool in a particularly advantageous manner.

The object mentioned above is independently achieved by a tool and/or a tool control unit, in particular for carrying out the method described above, including at least one acceleration sensor for measuring at least one, in particular two, preferably at least three, component(s) of the gravitational acceleration in the direction of one or two or three predetermined axes of the tool, the sensor preferably being (securely) connected to the tool. Owing to the fact that the sensor is (securely) connected to the tool, it participates in a rotation or tilting action of the tool and consequently indicates, owing to the component of the gravitational acceleration which changes during a rotation or tilting of the tool, a differing value. From the discrepancy of this value, it is possible in turn according to the invention to derive the tilting or the rotation of the tool or the position change thereof. A structurally simple determination of the position change can thereby be carried out.

According to a general notion (which is independently claimed), a use of an acceleration sensor is proposed, the acceleration sensor being (securely) connected to a (the) tool and measuring at least one component (or two or three components) of the gravitational acceleration in the direction of at least one (or two or three) predetermined axes of the tool.

According to a particularly preferred embodiment of the tool according to the invention or the tool control unit, the data which are produced by way of at least one sensor which is fitted to the tool are transmitted by way of a fixed conductor to the tool control unit or to a detection unit which co-operates with the tool control unit. Alternatively, the transmission may also be carried out in a wireless manner. Whilst the wireless transmission can be carried out, for example, by way of radio waves, the fixed conductor for transmitting the data produced by the sensor may be included together with other lines in a hose assembly which connects the tool and tool control unit. Both embodiments allow substantially unimpeded handling of the tool during the working operation. In particular, the use of a wireless sensor which itself co-operates with a detection unit which co-operates with the tool control unit allows an advantageous retrofitting of the tool and tool control unit so that they can also exploit the advantages and flexibility of the orientation or position determination.

According to another embodiment of the method according to the invention, the tool is a welding tool. It is also possible for the tool to be a joining tool or a drilling or milling tool, or a tool for carrying out coating operations, for example, a spray gun (or a spray or injection tool).

According to another embodiment of the tool according to the invention and tool control unit, at least one of the at least one sensors fitted to the tool is fitted to or in an operating handle or a hand portion of the tool. On the one hand, the fitting to an operating handle or a hand portion is a reliable type of fitting, in terms of any potential damage to the sensor, on the other hand, this fitting location also enables clear definition of the sensor position with respect to the position of the worker. Furthermore, fitting to an operating handle or a hand portion of the tool has been found to be relatively undisruptive during the working sequence since, on the one hand, neither the balance of the tool, nor the extent of the tool is influenced in such a manner that the worker would have to take into account disadvantages in the operating sequence.

According to another embodiment of the tool according to the invention and tool control unit, the information relating to the orientation of the tool and/or the at least one value of the at least one control variable is transmitted to the tool control unit or to a detection unit which co-operates with the tool control unit. The tool control unit is accordingly capable of processing the orientation information or the control variable with which it is supplied in an appropriate manner in order to select a suitable operating mode for the tool. Preferably, the provision of information relating to the orientation of the tool or the provision of the at least one control variable can be carried out by a microcontroller which calculates the appropriate variables before supplying the information to the tool control unit.

According to another embodiment of the tool according to the invention and the tool control unit, the tool control unit decides, based on the information relating to the orientation of the tool and/or the at least one value of the control variable, whether a change of the operating status of the tool is carried out. An embodiment according to which the control variable is already a control parameter which is to be processed directly by the tool control unit and which can be received and read in an unmodified form to control or regulate the tool has been found to be particularly advantageous in this instance.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

The invention is described below with reference to embodiments, which are explained in greater detail with reference to the drawings, in which in the drawings:

FIG. 1a shows a first embodiment of the tool according to the invention having a tool control unit in a tool position for determining a first position vector of the tool;

FIG. 1b shows the embodiment of the tool according to the invention shown in FIG. 1a having a tool control unit after a position change of the tool in order to determine a temporally subsequent position vector;

FIG. 1c is a schematic illustration of the position change of the tool, which is described by the tool positions according to FIGS. 1a and 1b;

FIG. 2 shows another embodiment of the tool according to the invention having a tool control unit;

FIG. 3 is a schematic illustration of a general spatial position change of the tool in order to determine at least one angular discrepancy between temporally successive position vectors;

FIG. 4 is a schematic illustration of two different spatial tool positions with reference to various regions which are associated with various operating modes of the tool;

FIG. 5 shows another embodiment of the method according to the invention for determining the complete spatial tool orientation; and

FIG. 6 is a flow chart to illustrate an embodiment of the method according to the invention.

### DETAILED DESCRIPTION OF THE INVENTION

In the following description, the same reference numerals are used for components which are the same or which have the same effect.

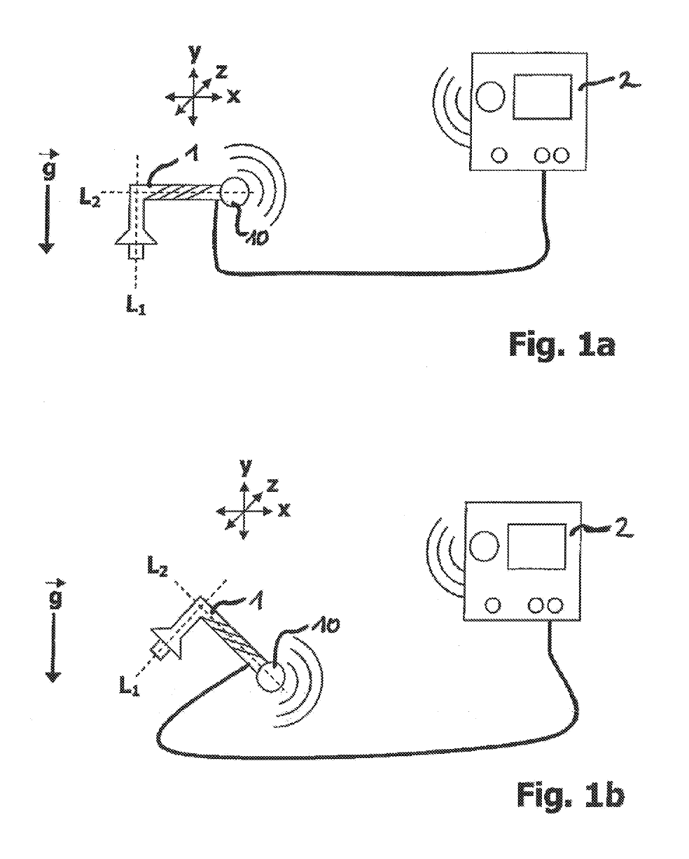

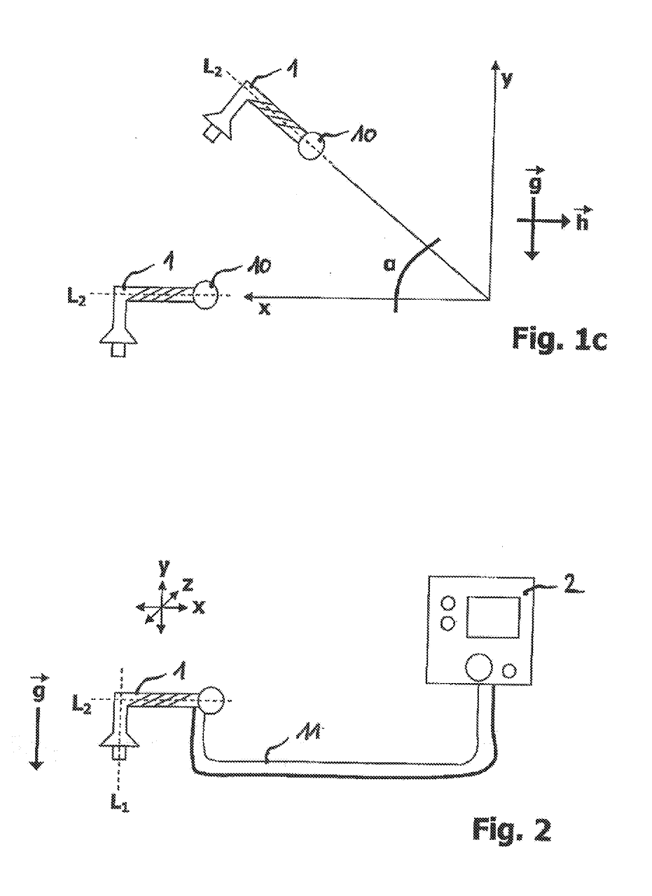

FIG. 1a is a schematic side view of a first embodiment of the tool 1 according to the invention having a tool control unit 2. In this instance, the tool 1 is preferably a welding tool. However, every other advantageous tool form according to the construction is also included by the illustration of the tool 1. The tool 1 is first freely arranged in space, which is illustrated by the schematically indicated coordinate system having the axes x, y and z. The tool 1 is preferably arranged with a fixedly predetermined arrangement relative to the direction of the field of gravitational acceleration, which is illustrated in this instance by \vec{g}. In this instance, the arrangement can be determined either relative to the axis L₂ which is orientated in the longitudinal extent direction of the handle of the tool 1, or along the axis L₁ which extends perpendicularly relative thereto and which extends in the longitudinal direction relative to the tool head of the tool 1. In order to determine the position change of the tool 1, a sensor 10 is provided at the end of the handle, which can communicate in a wireless manner with a receiver in the tool control unit 2. In this instance, the tool control unit 2 itself may include an appropriate receiver or be provided with another receiving member or another receiving unit which enables wireless communication.

In order to carry out the method according to the invention for determining a position change of a handheld tool in the embodiment, the initial tool position must first be aligned with a reference position in order to determine at least a first position vector of the tool. This operation is illustrated in FIG. 1a, in which the tool 1 is in a geometrically simple relationship with respect to the direction of the gravitational acceleration \vec{g}. If the tool 1 is temporally subsequently now moved by a worker relative to this initial position, as illustrated, for example, schematically in FIG. 1b, the sensor 10 establishes the change of the spatial position of the tool during the actual position change of the tool 1. The establishment is carried out in this instance according to the embodiment by establishing the static acceleration components in predetermined axes of the tool (which are defined, for example, by L₁ and/or L₂). The sensor 10 is preferably a three-dimensional acceleration sensor which also enables static acceleration components to be established. From the static acceleration portions which the sensor 10 detects, an angular discrepancy of a newly determined position vector is determined with reference to a temporally preceding position vector. According to the embodiment, the temporally preceding position vector is the first position vector, as illustrated in FIG. 1a. According to the embodiment, the first position vector may also be identical to the vector of the static gravitational acceleration \vec{g}.

The establishment of the change of the tool position during the actual position change of the tool 1 is carried out by determining at least one angular discrepancy (in this instance, precisely one angular discrepancy) α of the newly determined position vector in comparison with the temporally preceding position vector. FIG. 1c schematically shows this step of determining the at least one angular discrepancy α. In this instance, the longitudinal axis L₂ which extends in the longitudinal extent direction of the handle of the tool 1, was initially aligned for alignment with a direction perpendicular to the gravitational acceleration \vec{g}. The alignment allows the determination of at least a first position vector which is not illustrated in this instance but which extends in the x direction. After successfully changing the tool position, another position vector is determined (also not illustrated in this instance) so that an angular discrepancy α between the first and second position vector can be determined. This angular discrepancy α enables the provision of appropriate information relating to the orientation of the tool so that a tool control unit after obtaining this information can adjust an appropriate operating mode of the tool 1. The selection of the operating mode is in this instance dependent on the operating task.

It should be noted in this instance that the angular discrepancy α can be determined by the tool position initially being aligned with the direction or position of the vector of the gravitational acceleration \vec{g}. Accordingly, an alignment with the axis L₁ illustrated in FIG. 1a along the tool head of the tool 1 can be carried out

FIG. 2 illustrates another embodiment of the tool 1 according to the invention having a tool control unit 2 which differs from the embodiments illustrated in FIGS. 1a and 1b only in that the sensor 10 is connected to the tool control unit 2 not in a wireless manner but instead by way of a fixed conductor 11. In this instance, the fixed conductor 11 may also be included in a cable assembly together with other supply and discharge lines between the tool 1 and the tool control unit 2. Again it is possible for the transmission of the sensor data from the sensor 10 to the tool control unit to be carried out not directly but instead via a detection unit which is not illustrated in this instance and which is arranged upstream of the tool control unit 2.

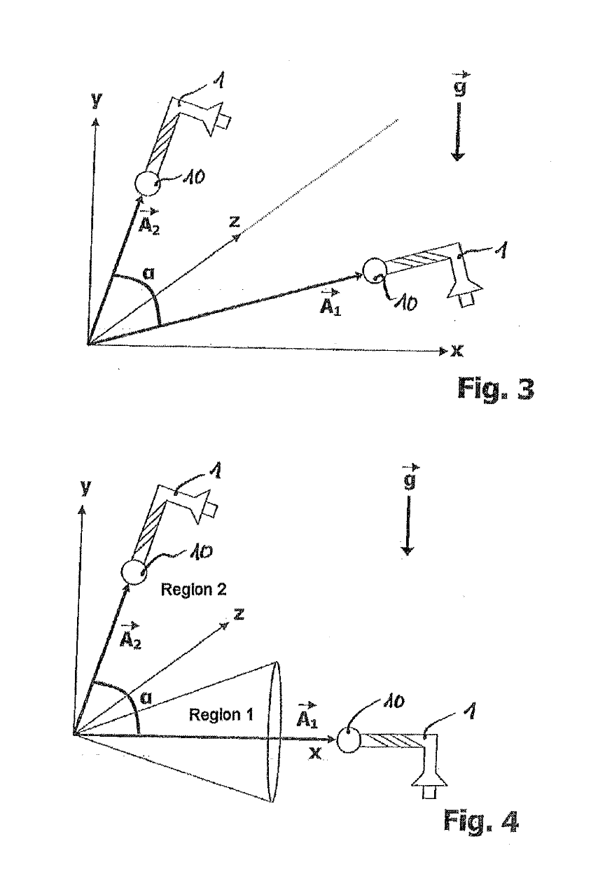

FIG. 3 is a schematic illustration of an embodiment of the method according to the invention, again indicating the explicit position vectors for determining a spatial angular discrepancy. In this instance, the tool 1 is first moved from a position which is described by the position vector \vec{A}₁ into a second position which is described by the position vector \vec{A}₂. The position change can be carried out freely in space in this instance. From the angular discrepancy of the two position vectors \vec{A}₁ and \vec{A}₂, the value of the angular discrepancy α is determined which is provided to establish information relating to the orientation of the tool 1. The position vector \vec{A}₁ may in this instance be the first position vector of the tool 1 which is substantially determined when the initial tool position is aligned with a reference position, but may also be a temporally subsequent position vector. In a particularly advantageous manner, the position vector \vec{A}₁ is determined with respect to the direction of the gravitational acceleration \vec{g}. To this end, the tool 1 is intended to be moved into a fixedly defined position with respect to the direction of the gravitational acceleration vector \vec{g} so that both are located in a fixed relationship with respect to each other. In particular, it is advantageous for the position vector \vec{A}₁ to extend parallel with the vector of the gravitational acceleration field \vec{g}.

FIG. 4 illustrates another embodiment of the method according to the invention for determining the spatial position change of a handheld tool. In this instance, the tool 1 is again moved from an initial position which is illustrated by the position vector \vec{A}₁ into a temporally subsequent position which is illustrated by the position vector \vec{A}₂ . Between both position vectors, an angular discrepancy α is determined. In accordance with the embodiment, information relating to the orientation of the tool is established from the angular discrepancy α determined and allows a differentiation to be made as to whether the tool is arranged in a region 1 or a region 2. Both regions are associated with an operating mode of the tool 1 so that, when the tool position moves from the region 1 into the region 2, a change of the operating mode is carried out. In this instance, it should also be noted that both regions 1 and 2 are spatially differentiated from each other only by an angular position of the tool 1. In particular, both regions are not regions of a co-ordinate system whose description would require the establishment of three spatial directions. In this instance, the region 1 is illustrated as a truncated cone whose tip corresponds to the origin of the coordinate system. Consequently, the tool is moved in any spatial direction about the angle α away from the initial position thereof illustrated by the position vector \vec{A}₁ , it being possible to determine using the calculated angular discrepancy α whether the tool 1 has been moved from the region 1 into the region 2. In the event of successful transfer, a change of the operating mode can be initiated by the tool control unit 2 which is not illustrated.

FIG. 5 illustrates another embodiment of the method according to the invention for determining a position change of a handheld tool which, in order to determine a precise spatial position or precise orientation of the tool 1, determines a total of three angular discrepancies α₁, α₂ and α₃. The angular discrepancy α₁ in this instance corresponds to an azimuth angle. The angular discrepancy α₂ corresponds to a polar angle. Both can be determined from appropriate trigonometric relationships of the position vector \vec{A}₁and the temporally subsequent position vector \vec{A}₂ . The angular discrepancy α₁ indicates in this instance the angular discrepancy of the vector \vec{P} which is projected in the x, z plane and which is determined from the projection of the position vector \vec{A}₂ in the x, z plane. In order to further be able to make statements relating to the relative rotation or orientation of the tool 1 with respect to the position vector \vec{A}₂ , another angular discrepancy α₃ is determined which establishes a rotation about the longitudinal extent direction of the handle of the tool 1. By establishing these three angular discrepancies α₁, α₂ and α₃, a more extensive and precise determination of the tool head with reference to its spatial position is possible, which may be required for carrying out more difficult operations or more complex geometries.

At this point, it should also be noted that the use of two or more angles may be significant both for the initialisation for alignment of the initial tool position with a reference position and for determining the temporally subsequent orientation of the tool. The initialisation may also be carried out, for example, via a plurality of position vectors in order consequently to be able to more completely describe the spatial position of the tool. For example, for a horizontal orientation of the tool 1, an additional item of orientation information can be provided as to whether and at what angle the tool is arranged in a position to the left or to the right of a workpiece. In principle, it is also possible to use any amount of position vectors of the tool 1 for initialisation, whose spatial positions can subsequently be calculated as required at a specific time. Owing to the initialisation, however, it is normally not necessary to describe or measure the tool in a precisely geometric manner.

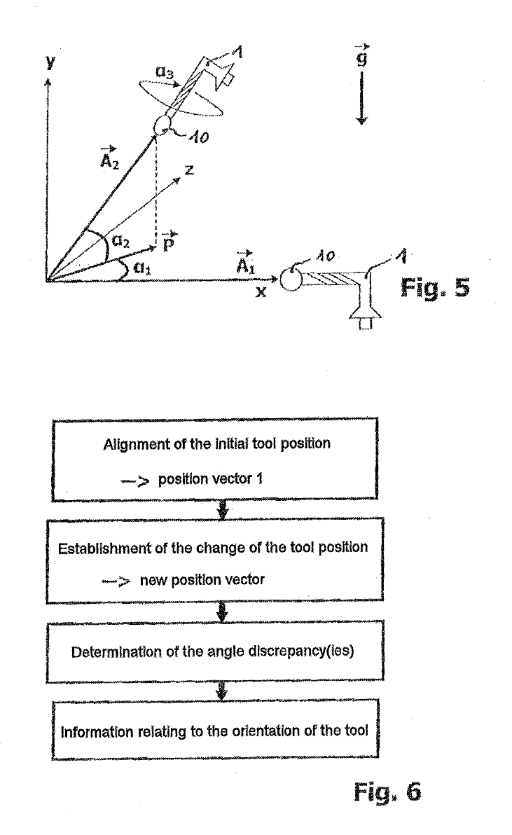

FIG. 6 is a flow chart for illustrating an embodiment of the method according to the invention for determining a position change of a handheld tool. In this instance, it is first necessary to align the initial tool position in order to determine a position vector 1. After successful alignment, the spatial position of the tool is suitably modified by the worker in the working process, the establishment of the modification of the tool position being able to be carried out by way of a temporally subsequent new position vector. The angular discrepancy of the position vector and the newly determined position vector enables conclusions to be drawn as to how the tool 1 has changed with respect to the reference position. According to the embodiment, the angular discrepancy or the angular discrepancies is/are provided as information relating to the orientation of the tool. The angular discrepancy or the angular discrepancies may also accordingly be processed in an alternative embodiment so that they contribute to establishing the information relating to the orientation of the tool.

At this point, it should be noted that all the components described above, considered alone and in any combination, in particular the details illustrated in the drawings, are claimed to be significant to the invention. Modifications thereto are commonplace for the person skilled in the art.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A method for determining a position change of a handheld tool (1) in space, the method comprising:
alignment of an initial tool position with a reference position in order to determine at least a first position vector of the tool, at least one component of the first position vector being determined by the measurement of a component of the gravitational acceleration in the direction of a predetermined axis of the tool (1);
establishing a modification of the tool position during an actual position change of the tool (1) in space by determining at least one angular discrepancy of a newly determined, second position vector of at least one temporally preceding position vector, at least one component of the second position vector being determined after the position change by measuring the component of the gravitational acceleration in the direction of the predetermined axis of the tool; and
providing information which relates to the orientation of the tool (1) and which is established from the at least one angular discrepancy.

2. The method according to claim 1, wherein the establishment of the modification of the tool position is carried out by way of at least one acceleration sensor (10) which is fitted to the tool and which directly or indirectly establishes the at least one angular discrepancy.

3. The method according to claim 1, wherein the at least one angular discrepancy is at least 0° and a maximum of 180°.

4. The method according to claim 1, wherein the determination of at least one angular discrepancy involves the determination of an inclined position of the tool (1) relative to a position vector.

5. The method according to claim 1, wherein, in order to establish the modification of the tool position, two or three components of the first or second position vector are determined by measuring two or three components of the gravitational acceleration in the direction of two or three predetermined axes of the tool.

6. The method according to claim 1, wherein the determination of the angular discrepancy is carried out by calculating the quotient from the scalar product and the absolute product between a newly established position vector and at least one temporally preceding position vector.

7. The method according to claim 2, wherein the at least one acceleration sensor is a static acceleration sensor and the at least one angular discrepancy is calculated by way of static acceleration values of the acceleration sensors.

8. The method according to claim 7, wherein the at least one acceleration sensor (10) comprises a three-axis acceleration sensor.

9. The method according to claim 7, wherein the at least one acceleration sensor (10) comprises three single-axis acceleration sensors.

10. The method according to claim 1, wherein acceleration values of at least one sensor (10) are calculated relative to the value of the gravitational acceleration.

11. The method according to claim 1, wherein the establishment of the information relating to the orientation of the tool from the at least one angular discrepancy takes into account the position of a sensor (10) on the tool (1).

12. The method according to claim 1, wherein the temporally preceding position vector for determining at least one angular discrepancy is a predetermined reference vector.

13. The method according to claim 12, wherein the predetermined reference vector is the vector of the gravitational force.

14. The method according to claim 1, wherein the alignment of an initial tool position with a reference position allows the determination of two position vectors of the tool (1), which are located perpendicularly relative to each other and which define a two-dimensional co-ordinate system, and the establishment of the change of the tool position during an actual spatial position change of the tool (1) involves the establishment of a newly determined position vector in projection onto the co-ordinate system.

15. A tool and/or tool control unit for carrying out a method according to claim 1, comprising at least one acceleration sensor for measuring at least one component of the gravitational acceleration in the direction of at least one predetermined axis of the tool, the sensor being connected to the tool.

16. The tool and/or tool control unit according to claim 15, wherein the at least one acceleration sensor measures at least two components of the gravitational acceleration in the direction of two predetermined axes of the tool.

17. The tool and/or tool control unit according to claim 15, wherein the at least one acceleration sensor measures at least three components of the gravitational acceleration in the direction of three predetermined axes of the tool.

18. The tool and/or tool control unit according to claim 15, wherein the tool (1) is one of a welding tool, a joining tool, a drilling tool, a milling tool, or a tool for carrying out coating operations.

19. The tool and/or tool control unit according to claim 15, wherein the at least one sensor (10) which is fitted to the tool (1) is fitted to or in an operating handle or a hand portion of the tool (1).
